(19) United States
(12) Patent Application Publication
(10) Pub. No.: US 2026/0108825 A1
(43) Pub. Date: Apr. 23, 2026

(54) WATER REMOVAL AND RECOVERY SYSTEM AND METHOD FOR LITHIUM BIS(FLUOROSULFONYL)IMIDE

(71) Applicants: Morimatsu (Jiangsu) Heavy Industry Co., Ltd., Rugao City (CN); Shanghai Morimatsu Engineering Technology Co., LTD, Shanghai (CN)

(72) Inventors: Yanbing HOU, Rugao City (CN); Koei NISHIMATSU, Rugao City (CN); Zhenxing LI, Rugao City (CN); Hongwei CHEN, Rugao City (CN); Sheng XU, Rugao City (CN); Lurong MAO, Rugao City (CN)

(21) Appl. No.: 19/154,530

(22) PCT Filed: Oct. 25, 2024
(86) PCT No.: PCT/CN2024/127245

§ 371 Date: Aug. 7, 2025

(30) Foreign Application Priority Data
Jun. 13, 2024 (CN) 202410757486.7

(51) Int. Cl. B01D 3/14; C01B 21/093

(52) U.S. Cl. CPC B01D 3/148; C01B 21/0935

(57) ABSTRACT

The present disclosure is provided with water removal and recovery system and method for lithium bis(fluorosulfonyl)imide. Specifically, the purification of lithium bis(fluorosulfonyl)imide crude products is achieved by two-stage thin film evaporators in series, thereby acquiring lithium bis(fluorosulfonyl)imide with sufficiently high purity with a relatively simple structure. The thin film evaporators themselves integrate the evaporation system and the condensation system, which not only simplifies the system configuration of connecting pipelines or tubs, but also lowers resistance and reduces the risk of system leakage. Furthermore, the solvents and water after evaporation can be effectively separated by a water separator, such that the content of organic phase solvents in the separated water is very low, and the content of water in the organic phase solvents is also very low. This allows for the maximum recovery of high-purity solvent for reuse, thereby facilitating the reduction of wastewater treatment costs.

### TECHNICAL FIELD

The present disclosure relates to the field of preparation of lithium bis(fluorosulfonyl)imide, in particular to a water removal and recovery system for lithium bis(fluorosulfonyl)imide and a water removal and recovery method for lithium bis(fluorosulfonyl)imide.

### BACKGROUND

In the field of lithium battery, lithium salt electrolyte is an important component of lithium battery. Lithium bis(fluorosulfonyl)imide has gained extensive application prospects in the field of lithium battery due to its excellent performance in terms of thermal stability, resistance to decomposition, and electrical conductivity. However, lithium bis(fluorosulfonyl)imide is highly sensitive to water and tends to decompose upon contact with water, which may degrade the performance and shorten the lifespan of lithium battery. According to existing water removal methods for lithium bis(fluorosulfonyl)imide, dehydrating agents are sometimes added to remove moisture. However, this approach may lead to impurity residues, preventing the attainment of high-quality lithium bis(fluorosulfonyl)imide.

Although those skilled in the art have proposed some solutions to purify lithium bis(fluorosulfonyl)imide, the systems used to implement these solutions are generally complicated in structure, and lack effective means for the separation and recovery of other solvents and water.

### SUMMARY

The present disclosure is made in view of the state of the prior art described above. One object of the present disclosure is to provide a water removal and recovery system for lithium bis(fluorosulfonyl)imide, which is capable of purifying a crude product of lithium bis(fluorosulfonyl)imide and also efficiently recovering and treating other solvents and water with a relatively simple structure. Another object of the present disclosure is to provide a water removal and recovery method for the lithium bis(fluorosulfonyl)imide, which is used in the above water removal and recovery system.

In order to achieve the above objects, the present disclosure applies the following technical solutions.

The present disclosure provides a water removal and recovery system for lithium bis(fluorosulfonyl)imide, comprising: a water separator configured to separate water and organic phase solvents for recovery respectively; a first thin film evaporator comprising a first feed port, a first light component discharge port, and a first heavy component discharge port, wherein the first feed port is configured to receive a product liquid, and the first light component discharge port is in communication with the water separator; and a second thin film evaporator comprising a second feed port, a second light component discharge port, and a second heavy component discharge port, wherein the second feed port is in communication with the first heavy component discharge port, and the second light component discharge port is in communication with the water separator.

According to an optional solution, the water separator comprises a first chamber and a second chamber, wherein the first chamber is communication with both the first light component discharge port and the second light component discharge port, a partition plate is provided between the first chamber and the second chamber, and a liquid in the first chamber may overflow over the partition plate into the second chamber.

According to another optional solution, there are further provided a first liquid level sensor and a first water separation regulating valve, wherein the first water separation regulating valve is connected to an outlet of the first chamber and is opened or closed based on a parameter detected by the first liquid level sensor, and the first liquid level sensor is provided in the water separator to sense a liquid level of a liquid in the first chamber; and/or there are further provided a second liquid level sensor and a second water separation regulating valve, wherein the second water separation regulating valve is connected to an outlet of the second chamber and is opened or closed based on a parameter detected by the second liquid level sensor, and the second liquid level sensor is arranged in the water separator to sense a liquid level of a liquid in the second chamber.

According to another optional solution, there are further provided a wastewater treatment device and a mixed solvent storage device, wherein the wastewater treatment device is connected to the outlet of the first chamber, and the mixed solvent storage device is connected to the outlet of the second chamber; and/or, there are further provided a first conveyance pump and a second conveyance pump, wherein the first conveyance pump and the second conveyance pump are connected to the first chamber and the second chamber, respectively, to convey the liquid in the first chamber and the second chamber out of the first chamber and the second chamber.

According to another optional solution, at least one of the first thin film evaporator and the second thin film evaporator is a short-range thin film evaporator.

According to another optional solution, there is further provided a drying device in communication with the second heavy component discharge port to dry heavy component substance from the second thin film evaporator to acquire lithium bis(fluorosulfonyl)imide.

According to another optional solution, there are further provided a solvent recovery device and a poor solvent storage device, wherein the solvent recovery device is in communication with the drying device and the poor solvent storage device such that a poor solvent from the drying device may enter the solvent recovery device for recovery and then be stored in the poor solvent storage device.

According to another optional solution, there are further provided a first temperature sensor and a first heat source regulating valve, wherein the first heat source regulating valve is opened or closed based on a parameter detected by the first temperature sensor, the first heat source regulating valve is provided in the first thin film evaporator, and the first temperature sensor is configured to sense an operating temperature in the first thin film evaporator; and/or there are further provided a second temperature sensor and a second heat source regulating valve, wherein the second heat source regulating valve is opened or closed based on a parameter detected by the second temperature sensor, the second heat source regulating valve is provided in the second thin film evaporator, and the second temperature sensor is configured to sense an operating temperature in the second thin film evaporator.

According to another optional solution, there is further provided a vacuum control device connected to the first thin film evaporator and the second thin film evaporator to control an operating pressure.

According to another optional solution, there are further provided a first pressure sensor and a first pressure regulating valve, wherein the first thin film evaporator is in controlled communication with the vacuum control device through the first pressure regulating valve, the first pressure regulating valve is opened or closed based on a parameter detected by the first pressure sensor, and the first pressure sensor is provided in the first thin film evaporator to sense an operating pressure in the first thin film evaporator; and/or there are further provided a second pressure sensor and a second pressure regulating valve, wherein the second thin film evaporator is in controlled communication with the vacuum control device through the second pressure regulating valve, the second pressure regulating valve is opened or closed based on a parameter detected by the second pressure sensor, and the second pressure sensor is provided in the second thin film evaporator to sense an operating pressure in the second thin film evaporator.

According to another optional solution, there are further provided an exhaust gas treatment device and a waste liquid treatment device, wherein the exhaust gas treatment device and the waste liquid treatment device are connected to the vacuum control device to treat an exhaust gas and a waste liquid from the vacuum control device.

The present disclosure further provides a water removal and recovery method for lithium bis(fluorosulfonyl)imide, which is used in the water removal and recovery system for lithium bis(fluorosulfonyl)imide according to any one of the above technical solutions. The water removal and recovery method comprises: a feeding step, in which a product liquid containing lithium bis(fluorosulfonyl)imide, water, and other solvents is conveyed into the first thin film evaporator via the first feed port; a first evaporation separation step, in which light component substance separated by the first thin film evaporator enters the water separator via the first light component discharge port for separation and recovery in the water separator, and heavy component substance separated by the first thin film evaporator enters the second thin film evaporator via the first heavy component discharge port and the second feed port; and a second evaporation separation step, in which light component substance separated by the second thin film evaporator enters the water separator via the second light component discharge port for separation and recovery in the water separator, and heavy component substance separated by the second thin film evaporator is conveyed out via the second heavy component discharge port.

According to an optional solution, the water removal and recovery system further comprises a drying device, and the water removal and recovery method further comprises a drying step, in which the heavy component substance from the second thin film evaporator is dried and crystallized in the drying device to acquire lithium bis(fluorosulfonyl)imide.

According to another optional solution, the water separator comprises a first chamber and a second chamber, with a partition plate provided between the first chamber and the second chamber. The water removal and recovery method further comprises a light component separation step, in which light component substance entering the first chamber of the water separator contains immiscible water and organic phase solvents, and the organic phase solvents in the first chamber may overflow over the partition plate into the second chamber of the water separator.

By applying the above technical solution, the present disclosure provides a water removal and recovery system and a method for lithium bis(fluorosulfonyl)imide. The water removal and recovery system for lithium bis(fluorosulfonyl)imide comprises a water separator, a first thin film evaporator, a second thin film evaporator, and a drying device. The water separator is configured to separate water and organic phase solvents. The first thin film evaporator comprises a first feed port, a first light component discharge port, and a first heavy component discharge port. The first feed port is configured to receive a product liquid, which contains lithium bis(fluorosulfonyl)imide, water, and other solvents, and the first light component discharge port is in communication with the water separator. The second thin film evaporator comprises a second feed port, a second heavy component discharge port, and a second light component discharge port. The second feed port is in direct and constant communication with the first heavy component discharge port, and the second light component discharge port is in communication with the water separator.

In this way, on the one hand, the application of two-stage thin film evaporators in series achieves the purification of the crude product of lithium bis(fluorosulfonyl)imide, thereby acquiring lithium bis(fluorosulfonyl)imide of sufficiently high purity with a relatively simple structure. The moisture content of lithium bis(fluorosulfonyl)imide may be controlled at 50 ppm or below (ppm denotes parts per million). Moreover, the thin film evaporators themselves integrate the evaporation system and the condensation system, and the two-stage film evaporations are in direct communication with each other. This not only simplifies the system structure of the connecting pipelines or tubes, but also lowers resistance and reduces the risk of system leakage. On the other hand, after the purification and separation treatment, the solvents and water may be effectively separated through the water separator, such that the content of the organic phase solvents in the separated water is within 2%, and the content of water in the organic phase solvents is within 0.1%. In this way, it is possible to recover high-purity solvents as much as possible for reuse, which is also conducive to reducing the cost of wastewater treatment.

### BRIEF DESCRIPTION OF THE DRAWINGS

FIG. 1 is a schematic view showing a topological structure of a water removal and recovery system for lithium bis(fluorosulfonyl)imide according to an embodiment of the present disclosure.

FIG. 2 is a schematic flow chart showing a water removal and recovery method for lithium bis(fluorosulfonyl)imide used in the system in FIG. 1.

### REFERENCE LIST

1a water separator; 11 first chamber; 12 second chamber; 13 partition plate; 1b wastewater treatment device; 1c mixed solvent storage device;
2 first thin film evaporator; 21 first feed port; 22 first light component discharge port; 23 first heavy component discharge port;
3 second thin film evaporator; 31 second feed port; 32 second light component discharge port; 33 second heavy component discharge port;
4 drying device;
5a vacuum control device; 5b exhaust gas treatment device; 5c waste liquid treatment device;
6a solvent recovery device; 6b poor solvent storage device;
TC1 first temperature sensor; TC2 second temperature sensor; PC1 first pressure sensor; PC2 second pressure sensor; LC1 first liquid level sensor; LC2 second liquid level sensor; TV1 first heat source regulating valve; TV2 second heat source regulating valve; PV1 first pressure regulating valve; PV2 second pressure regulating valve; WV1 first water separation regulating valve; WV2 second water separation regulating valve; PU1 first conveyance pump; PU2 second conveyance pump.

### DETAILED DESCRIPTION

Hereinafter, exemplary embodiments of the present disclosure will be described with reference to the accompanying drawings. It is appreciated that these specific descriptions are only intended to teach those skilled in the art how to implement the present disclosure, rather than to exhaust all possible implementations of the present disclosure, nor to limit the scope of the present disclosure.

In the present disclosure, the communication between two objects (including but not limited to the respective devices) means that an inlet of one object is in communication with an outlet of the other object, which may use some pipelines or tubes. In the drawings, the arrows on the connecting lines which represent the pipelines or tubes indicate the direction of flow of the fluid in the pipelines or tubes.

In the present disclosure, “communication” includes constant communication and controlled communication. The constant communication means that the pipeline or tube between two objects may always be in a communication state, while the controlled communication means that the pipeline or tube between two objects may be controlled to be in a communication state or a non-communication state.

In the present disclosure, the various valves being “opened or closed” includes fully opening a valve, fully closing a valve, and controllably adjusting the opening of a valve.

Hereinafter, a water removal and recovery system for lithium bis(fluorosulfonyl)imide according to an embodiment of the present disclosure will be described with reference to the accompanying drawings.

### A Water Removal and Recovery System for Lithium Bis(fluorosulfonyl)imide According to an Embodiment of the Present Disclosure

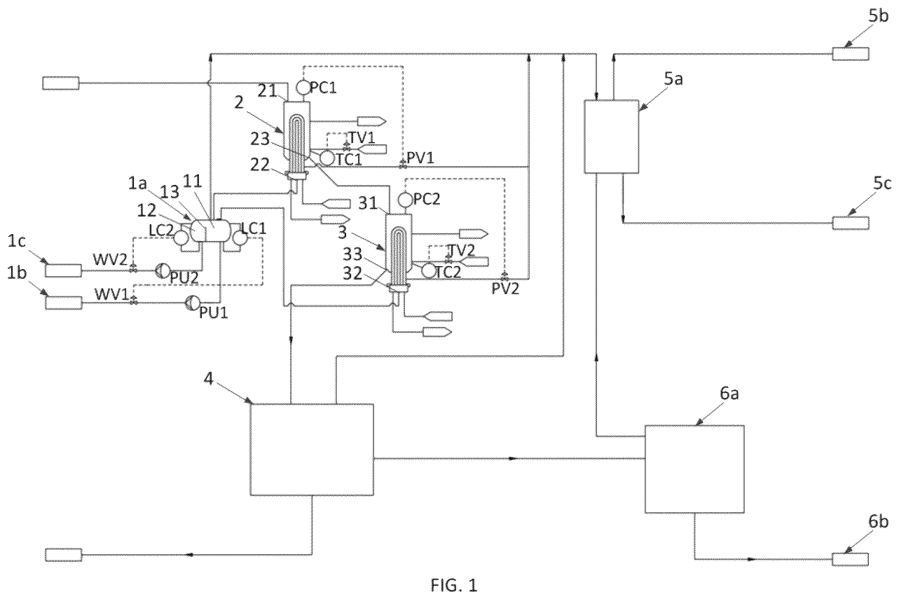

As shown in FIG. 1, a water removal and recovery system for lithium bis(fluorosulfonyl)imide according to an embodiment of the present disclosure may comprise a water separator 1a, a wastewater treatment device 1b, a mixed solvent storage device 1c, a first thin film evaporator 2, a second thin film evaporator 3, a drying device 4, a vacuum control device 5a, an exhaust gas treatment device 5b, a waste liquid treatment device 5c, a solvent recovery device 6a, and a poor solvent storage device 6b. In this water removal and recovery system, the two-stage thin film evaporators 2 and 3 in series and the drying device 4 can serve the purpose of purifying lithium bis(fluorosulfonyl)imide and can remove impurities, moisture, and the like in lithium bis(fluorosulfonyl)imide. In addition, the water separator 1a, the wastewater treatment device 1b, the mixed solvent storage device 1c, the solvent recovery device 6a, and the poor solvent storage device 6b can effectively treat and recover the separated water and solvent, respectively, which is beneficial to the recovery and reuse of the solvents and is beneficial to the treatment of the wastewater.

In this embodiment, the water separator 1a may be a horizontal water separator, which can effectively separate water and the organic phase solvents in the light component substances from the two-stage thin film evaporators. Specifically, as shown in FIG. 1, the interior of the water separator 1a is formed with a first chamber 11 and a second chamber 12, with a partition plate 13 provided between the first chamber 11 and the second chamber 12; and the first chamber 11 and the second chamber 12 are in communication with each other through a passage above the partition plate 13 such that after the liquid in the first chamber 11, which contains immiscible water and organic phase solvents, is full or nearly full, the organic phase solvents at the upper layer can overflow into the second chamber 12, while the water at the lower layer can still remain in the first chamber 11. To this end, the first chamber 11 is in constant and direct communication with the first light component discharge port 22 of the first thin film evaporator 2 and the second light component discharge port 32 of the second thin film evaporator 3. The light component substances separated in the two thin film evaporators 2 and 3 will enter the first chamber 11 of the water separator 1a, such that the water and the organic phase solvents in the light component substances entering the water separator 1a can be fully separated from each other.

In addition, as shown in FIG. 1, the water removal and recovery system further comprises a first liquid level sensor LC1, a second liquid level sensor LC2, a first water separation regulating valve WV1, a second water separation regulating valve WV2, a first conveyance pump PU1, and a second conveyance pump PU2. The outlet at the bottom of the first chamber 11 is in controlled communication with the wastewater treatment device 1b through the first water separation regulating valve WV1, and the first water separation regulating valve WV1 is opened or closed based on a parameter detected by the first liquid level sensor LC1. The first liquid level sensor LC1 is provided in the water separator 1a to sense the liquid level of the liquid in the first chamber 11. The first water separation regulating valve WV1 and the first liquid level sensor LC1 may be in electrical connection or in signal connection. It is appreciated that the electrical connection or signal connection can be indirectly achieved through a controller, thereby enabling the control described above. The electrical connection or signal connection described herein can be achieved in the same manner, and will not be repeatedly described in the following. The outlet at the bottom of the second chamber 12 is in controlled communication with the mixed solvent storage device 1c through the second water separation regulating valve WV2. The second water separation regulating valve WV2 is opened or closed based on a parameter detected by the second liquid level sensor LC2. The second liquid level sensor LC2 is provided in the water separator 1a to sense the liquid level of the liquid in the second chamber 12. The second water separation regulating valve WV2 and the second liquid level sensor LC2 may be in electrical connection or in signal connection. Furthermore, the liquid from the first chamber 11 can be conveyed to the wastewater treatment device 1b through the first conveyance pump PU1, and the liquid from the second chamber 12 can be conveyed to the mixed solvent storage device 1c through the second conveyance pump PU2. It is appreciated that the monitoring by the highly sensitive first liquid level sensor (liquid level gauge) LC1 ensures that the water in the first chamber 11 does not enter the second chamber 12, thus achieving effective separation of the water and the organic phase solvents.

In this embodiment, as shown in FIG. 1, a housing of the first thin film evaporator 2 is provided with a first feed port 21, a first light component discharge port 22, and a first heavy component discharge port 23. The first feed port 21 is provided at the top of the first thin film evaporator 2 to receive a product liquid. The product liquid contains lithium bis(fluorosulfonyl)imide, water, and other solvents. It is appreciated that, in the present disclosure, the other solvents may include good solvents and poor solvents. The good solvents and the poor solvents may include, but are not limited to, alkoxyethane solvents selected from one or more of diethyl ether, diisopropyl ether, methyl tert-butyl ether, dimethoxyethane, and diethoxyethane; ester solvents selected from one or more of methyl acetate, ethyl acetate, propyl acetate, and butyl acetate; nitrile solvents selected from one or more of acetonitrile, propionitrile, and butyronitrile; and nitroalkane solvents selected from one or more of nitromethane, nitroethane, nitropropane, and nitrobutane; hydrocarbon solvents selected from one or more of pentane, hexane, and heptane; aromatic solvents selected from one or more of benzene, toluene, and xylene; alcohol solvents selected from one or more of methanol, ethanol, propanol, and butanol; ketone solvents selected from one or more of acetone, methyl ethyl ketone, and methyl isopropyl ketone; and dialkyl carbonate solvents selected from one or more of dimethyl carbonate, diethyl carbonate, and ethyl methyl carbonate. The first light component discharge port 22 is located at the bottom of the first thin film evaporator 2 and is in communication with the first chamber 11, allowing the light component substance from the first thin film evaporator 2 to enter the first chamber 11. The first heavy component discharge port 23 is located on a side of the first thin film evaporator 2 to convey the heavy component substance from the first thin film evaporator 2 to the second thin film evaporator 3. A housing of the second thin film evaporator 3 is provided with a second feed port 31, a second light component discharge port 32, and a second heavy component discharge port 33. The second feed port 31 is located at the top of the second thin film evaporator 3 and is in communication with the first heavy component discharge port 23 to receive the heavy component substance from the first thin film evaporator 2. The second light component discharge port 32 is located at the bottom of the second thin film evaporator 3 and is in communication with the first chamber 11, allowing the light component substance from the second thin film evaporator 3 to enter the first chamber 11. The second heavy component discharge port 33 is located on a side of the second thin film evaporator 3 to convey the heavy component substance from the second thin film evaporator 3 to the drying device 4.

In this embodiment, the first thin film evaporator 2 and the second thin film evaporator 3 may adopt the same type of short-range thin film evaporator and have the same internal structure, and are configured to achieve thermal separation under certain operating pressure conditions. Such a short-range thin film evaporator may, for example, comprise a cylindrical housing with a heating jacket, a rotor, and a built-in condenser. Additionally, a film scraper and an anti-splash device are mounted to a fixed frame of the rotor. The built-in condenser is located at the center of the short-range thin film evaporator, with the rotor rotating between the cylindrical housing and the built-in condenser. The following is a brief description of its working process. The material is fed into the short-range thin film evaporator via the feed port at the top; the rotor continuously and uniformly distributes the material onto a heating surface; the film scraper scrapes the material to form an extremely thin and turbulent liquid film, and propels it downward in a spiral motion. During this process, the light component substance escaping from the heating surface travels a short path and reaches the built-in condenser almost without collision, where it condenses into liquid and flows down along the condenser tube (the condensation of the built-in condenser may be achieved by means of a cold source, and there is no need to provide a regulating valve to control the cold source), and then is discharged via the light component discharge port at the bottom of the short-range evaporator. The remaining heavy component substance is collected in a channel below the heating zone and then discharged via the heavy component discharge port located on the side. The short-range thin film evaporator integrates an external condenser into the interior of the cylindrical housing, minimizing a gap between an outer wall of the condenser tube and a heating wall surface of the cylindrical housing. This allows the evaporated light component substance to be quickly cooled into the liquid phase after traveling only a short distance, reducing the liquid phase condensation time and enhancing separation efficiency. Moreover, the system using two stages in series greatly ensures the complete separation of the solvents, water, and lithium bis(fluorosulfonyl)imide.

To regulate the operating temperature of the first thin film evaporator 2, as shown in FIG. 1, the water removal and recovery system further comprises a first temperature sensor TC1 and a first heat source regulating valve TV1. The first heat source regulating valve TV1 may be in electrical connection or in signal connection to the first temperature sensor TC1. The first heat source regulating valve TV1 is opened or closed based on a parameter detected by the first temperature sensor TC1. The first heat source regulating valve TV1 is provided at a heat source inlet of the first thin film evaporator 2 to control the flow of the heat source, and the first temperature sensor TC1 is configured to sense the operating temperature inside the first thin film evaporator 2. As shown in FIG. 1, to regulate the operating temperature of the second thin film evaporator 3, the water removal and recovery system further comprises a second temperature sensor TC2 and a second heat source regulating valve TV2. The second heat source regulating valve TV2 may be in electrical connection or in signal connection to the second temperature sensor TC2. The second heat source regulating valve TV2 is opened or closed based on a parameter detected by the second temperature sensor TC2. The second heat source regulating valve TV2 is provided at a heat source inlet of the second thin film evaporator 3 to control the flow of the heat source, and the second temperature sensor TC2 is configured to sense the operating temperature inside the second thin film evaporator 3.

In this embodiment, as shown in FIG. 1, the drying device 4 is in constant and direct communication with the second heavy component discharge port 33. After the heavy component substance from the second thin film evaporator 3 is dried by the drying device 4, lithium bis(fluorosulfonyl)imide with very high purity (the moisture content can be controlled below 50 ppm) can be acquired. The outlet of the drying device 4 may be in communication with a packaging device, allowing the lithium bis(fluorosulfonyl)imide from the drying device 4 to be directly packaged.

In this embodiment, as shown in FIG. 1, in order to control the operating pressure inside the first thin film evaporator 2 and the second thin film evaporator 3 through a vacuum control device, the vacuum control device 5a is in communication with the first thin film evaporator 2 and the second thin film evaporator 3. In addition, the water removal and recovery system further comprises a first pressure sensor PC1, a first pressure regulating valve PV1, a second pressure sensor PC2, and a second pressure regulating valve PV2. The first thin film evaporator 2 is in controlled communication with the vacuum control device 5a through the first pressure regulating valve PV1. The first pressure regulating valve PV1 is in electrical connection or in signal connection to the first pressure sensor PC1. The first pressure regulating valve PV1 is opened or closed based on a parameter detected by the first pressure sensor PC1. The first pressure sensor PC1 is provided in the first thin film evaporator 2 to sense the operating pressure inside the first thin film evaporator 2. The second thin film evaporator 3 is in controlled communication with the vacuum control device 5a through the second pressure regulating valve PV2. The second pressure regulating valve PV2 is in electrical connection or in signal connection to the second pressure sensor PC2. The second pressure regulating valve PV2 is opened or closed based on a parameter detected by the second pressure sensor PC2. The second pressure sensor PC2 is provided in the second thin film evaporator 3 to sense the operating pressure inside the second thin film evaporator 3.

Furthermore, as shown in FIG. 1, the vacuum control device 5a is further in communication with the water separator 1a and the solvent recovery device 6a to control the operating pressure inside the water separator 1a and the solvent recovery device 6a. In addition, the vacuum control device 5a is in constant and direct communication with the exhaust gas treatment device 5b and the waste liquid treatment device 5c. In this way, the exhaust gas from the vacuum control device 5a may directly enter the exhaust gas treatment device 5b for treatment, and the waste liquid from the vacuum control device 5a may enter the waste liquid treatment device 5c for treatment. This prevents the exhaust gas and the waste liquid from adversely affecting the normal operation of the vacuum control device 5a and also prevents potential environmental pollution caused by them. Additionally, the solvent recovery device 6a is in constant and direct communication with the drying device 4 and the poor solvent storage device 6b, allowing the poor solvents from the drying device 4 to enter the solvent recovery device 6a for recovery and then be stored in the poor solvent storage device 6b.

A water removal and recovery method which is used in the water removal and recovery system for lithium bis(fluorosulfonyl)imide according to an embodiment of the present disclosure is described in the following.

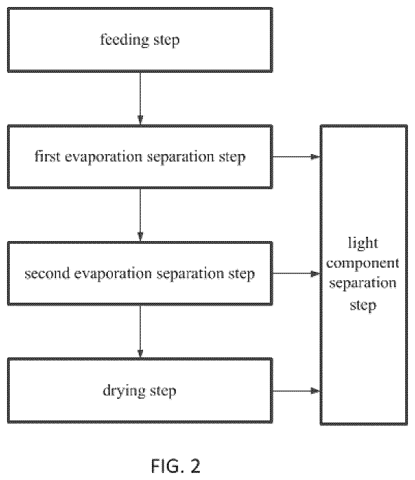

Specifically, as shown in FIG. 2, the water removal and recovery method according to the present disclosure comprises a feeding step, a first evaporation separation step, a second evaporation separation step, a drying step, and a light component separation step, wherein the feeding step, the first evaporation separation step, the second evaporation separation step, and the drying step may be carried out in sequence.

In a reaction vessel, a crude product liquid is acquired from a lithiation reaction of lithium salt and bis(fluorosulfonyl)imide. In the feeding step, the crude product liquid is filtered by a filtration device, and a resulting product liquid containing lithium bis(fluorosulfonyl)imide, water, and other solvents is fed into the first thin film evaporator 2 via the first feed port 21.

In the first evaporation separation step, the product liquid fed into the first thin film evaporator 2 undergoes evaporation and concentration. The operating pressure of the first thin film evaporator 2 is interlock-controlled by the first pressure sensor PC1 and the first pressure regulating valve PV1 within a range of −0.080 MPaG to −0.099 MPaG (MPaG denotes a gauge pressure). The operating temperature of the first thin film evaporator 2 is interlock-controlled by the first temperature sensor TC1 and the first heat source regulating valve TV1 within a range of 10° C. to 50° C. The light component substance evaporated from the first thin film evaporator 2, which contains water and organic phase solvents, enters the first chamber 11 of the water separator la via the first light component discharge port 22 for separation in the water separator 1a. Meanwhile, the heavy component substance containing lithium bis(fluorosulfonyl)imide enters the second thin film evaporator 3 via the first heavy component discharge port 23 and the second feed port 31.

In the second evaporation separation step, the heavy component substance conveyed to the second thin film evaporator 3 undergoes further evaporation and concentration. The operating pressure and the operating temperature of the second thin film evaporator 3 may be the same as those of the first thin film evaporator 2. The light component substance evaporated from the second thin film evaporator 3 enters the first chamber 11 of the water separator 1a via the second light component discharge port 32 for separation in the water separator 1a, while the heavy component substance enters the drying device 4 via the second heavy component discharge port 33.

In the drying step, the heavy component substance from the second thin film evaporator 3 is dried in the drying device 4, followed by crystallization to acquire lithium bis(fluorosulfonyl)imide with sufficiently high purity.

In addition, as shown in FIG. 2, the light component separation step may be performed simultaneously with the first evaporation separation step, the second evaporation separation step, and the drying step, or it may be performed after these three steps. In the light component separation step, the light component substance entering the first chamber 11 of the water separator 1a contains immiscible water and organic phase solvents. When the first chamber 11 is full or nearly full, the organic phase solvents can overflow over the partition plate 13 into the second chamber 12 of the water separator 1a. That is to say, the organic phase solvents at the upper layer in the first chamber 11 may overflow into the second chamber 12 of the water separator 1a through a gap between the top end of the partition plate 13 and the housing of the water separator 1a, while the water at the lower layer in the first chamber 11 will be retained in the first chamber 11. In the light component separation step, the operating pressure P of the water separator 1a may be adjusted by the vacuum control device 5a to be within a range of −0.099 MPaG≤P≤−0.080 MPaG, and the operating temperature T of the water separator 1a may be adjusted to be within a range of 50° C.≥T≥10° C. Under these operating pressure and operating temperature conditions, the water separator 1a can achieve more effective separation of water and the organic phase solvents.

It is appreciated that the embodiments described above are for illustrative purposes only, and are not intended to restrict the present disclosure. Various modifications or changes may be made by those skilled in the art to the above embodiments under the teaching of the present disclosure, without departing from the scope of the present disclosure. Further, the following supplementary explanations are provided.

i. In the above embodiments of the present disclosure, two-stage series-connected short-range thin film evaporators 2 and 3 in series are used. By taking advantage of the differences in boiling points, water in lithium bis(fluorosulfonyl)imide is effectively removed and the solvents are separated. There is no need to introduce a dehydrating agent, thus avoiding the excessive content of chloride ions and acid radical ions in the product due to the introduction of foreign substances, and ensuring the quality of lithium bis(fluorosulfonyl)imide.

Additionally, the water-containing mixed solvent is separated into water and the organic phase solvents by the water separator 1a. The water separator 1a comprises two chambers 11 and 12. Whether the first chamber 11 is in communication with the wastewater treatment device 1b is interlock-controlled by the first liquid level sensor LC1 and the first water separation regulating valve WV1 provided in the pipeline, which enables the solvent content in the discharged water to be controlled within 2% and thus reduces the difficulty of post-treatment of the wastewater. The organic phase solvents, as the liquid level rises, overflow over the partition plate 13 into the second chamber 12. Whether the second chamber 12 is in communication with the mixed solvent storage device 1c is interlock-controlled by the second liquid level sensor LC2 and the second water separation regulating valve WV2 provided in the pipeline, which enables the water content in the discharged organic phase solvents to be controlled within 0.1%.

ii. In the above embodiments of the present disclosure, the short-range thin film evaporators 2 and 3 integrate the evaporation system with the condensation system, reducing the need for connecting pipelines, instruments, valves, and the like between the systems. As a result, there is no pipeline resistance, and the risk of leakage at connection points is minimized. This ensures the internal vacuum level of the entire system, lowers the evaporation temperature, and reduces energy consumption by 20%.

iii. In the above embodiments of the present disclosure, the thin film evaporators 2 and 3 in the water removal and recovery system of the present disclosure are short-range thin film evaporators. However, the present disclosure is not limited to this. For example, other types of thin film evaporators may also be used.

iv. In the variants of the above embodiments of the present disclosure, a configuration comprising only the thin film evaporators 2 and 3 in series and the water separator 1a that is in communication with both the thin film evaporators 2 and 3 may be adopted. This can further simplify the structure of the entire water removal and recovery system. Correspondingly, the steps of the water removal and recovery method which uses the system in the variants can also be simplified. It is appreciated that, based on the above variants, various other components can be provided as needed to execute appreciated the desired functions could be realized by providing various other components, thereby enabling other variants. Here, the structures of these other variants will not be described in detail.

v. The system of the present disclosure is capable of continuous production, thereby significantly increasing capacity, reducing the production cost of lithium bis(fluorosulfonyl)imide, and improving the production efficiency of lithium bis(fluorosulfonyl)imide.

What is claimed is:

1. A water removal and recovery system for lithium bis(fluorosulfonyl)imide, comprising:
a water separator configured to separate water and organic phase solvents for recovery respectively, the water separator comprising a first chamber and a second chamber, with a partition plate provided between the first chamber and the second chamber, and a liquid in the first chamber being able to overflow over the partition plate into the second chamber;
a first thin film evaporator, which is a short-range thin film evaporator and which comprises a first feed port, a first light component discharge port, and a first heavy component discharge port, the first feed port being configured to receive a product liquid which contains lithium bis(fluorosulfonyl)imide, water, and other solvents, and the first light component discharge port being in direct communication with the first chamber of the water separator;
a second thin film evaporator, which is a short-range thin film evaporator and which comprises a second feed port, a second light component discharge port, and a second heavy component discharge port, the second feed port being in communication with the first heavy component discharge port, and the second light component discharge port being in direct communication with the first chamber of the water separator; and
a drying device, which is in communication with the second heavy component discharge port and configured to dry and crystallize a heavy component substance from the second thin film evaporator to acquire lithium bis(fluorosulfonyl)imide.

2. The water removal and recovery system for lithium bis(fluorosulfonyl)imide according to claim 1, further comprising:
a first liquid level sensor and a first water separation regulating valve, the first water separation regulating valve is connected to an outlet of the first chamber and is opened or closed based on a parameter detected by the first liquid level sensor, and the first liquid level sensor is provided in the water separator to sense a liquid level of liquid in the first chamber; and/or
a second liquid level sensor and a second water separation regulating valve, the second water separation regulating valve is connected to an outlet of the second chamber and is opened or closed based on a parameter detected by the second liquid level sensor, and the second liquid level sensor is provided in the water separator to sense a liquid level of liquid in the second chamber.

3. The water removal and recovery system for lithium bis(fluorosulfonyl)imide according to claim 1, further comprising:
a wastewater treatment device and a mixed solvent storage device, the wastewater treatment device is connected to an outlet of the first chamber, and the mixed solvent storage device is connected to an outlet of the second chamber; and/or
a first conveyance pump and a second conveyance pump, the first conveyance pump and the second conveyance pump are connected to the first chamber and the second chamber, respectively, to convey liquid in the first chamber and the second chamber out of the first chamber and the second chamber.

4. The water removal and recovery system for lithium bis(fluorosulfonyl)imide according to claim 1, further comprising a solvent recovery device and a poor solvent storage device, the solvent recovery device is in communication with the drying device and the poor solvent storage device such that poor solvent from the drying device is capable of entering the solvent recovery device for recovery and then being stored in the poor solvent storage device.

5. The water removal and recovery system for lithium bis(fluorosulfonyl)imide according to claim 1, further comprising:
a first temperature sensor and a first heat source regulating valve, the first heat source regulating valve is opened or closed based on a parameter detected by the first temperature sensor, the first heat source regulating valve is provided in the first thin film evaporator, and the first temperature sensor is configured to sense an operating temperature in the first thin film evaporator; and/or
a second temperature sensor and a second heat source regulating valve, the second heat source regulating valve is opened or closed based on a parameter detected by the second temperature sensor, the second heat source regulating valve is provided in the second thin film evaporator, and the second temperature sensor is configured to sense an operating temperature in the second thin film evaporator.

6. The water removal and recovery system for lithium bis(fluorosulfonyl)imide according to claim 1, further comprising a vacuum control device connected to the first thin film evaporator and the second thin film evaporator to control operating pressures.

7. The water removal and recovery system for lithium bis(fluorosulfonyl)imide according to claim 6, further comprising:
a first pressure sensor and a first pressure regulating valve, the first thin film evaporator is in controlled communication with the vacuum control device through the first pressure regulating valve, the first pressure regulating valve is opened or closed based on a parameter detected by the first pressure sensor, and the first pressure sensor is arranged in the first thin film evaporator to sense an operating pressure in the first thin film evaporator; and/or
a second pressure sensor and a second pressure regulating valve, the second thin film evaporator is in controlled communication with the vacuum control device through the second pressure regulating valve, the second pressure regulating valve is opened or closed based on a parameter detected by the second pressure sensor, and the second pressure sensor is provided in the second thin film evaporator to sense an operating pressure in the second thin film evaporator.

8. The water removal and recovery system for lithium bis(fluorosulfonyl)imide according to claim 6, further comprising an exhaust gas treatment device and a waste liquid treatment device, the exhaust gas treatment device and the waste liquid treatment device are connected to the vacuum control device to treat exhaust gas and waste liquid from the vacuum control device.

9. A water removal and recovery method for lithium bis(fluorosulfonyl)imide, wherein the water removal and recovery method for lithium bis(fluorosulfonyl)imide is used in a water removal and recovery system for lithium bis(fluorosulfonyl)imide compromising:
a water separator configured to separate water and organic phase solvents for recovery respectively, the water separator comprising a first chamber and a second chamber, with a partition plate provided between the first chamber and the second chamber, and a liquid in the first chamber being able to overflow over the partition plate into the second chamber;
a first thin film evaporator, which is a short-range thin film evaporator and which comprises a first feed port, a first light component discharge port, and a first heavy component discharge port, the first feed port being configured to receive a product liquid which contains lithium bis(fluorosulfonyl)imide, water, and other solvents, and the first light component discharge port being in direct communication with the first chamber of the water separator;
a second thin film evaporator, which is a short-range thin film evaporator and which comprises a second feed port, a second light component discharge port, and a second heavy component discharge port, the second feed port being in communication with the first heavy component discharge port, and the second light component discharge port being in direct communication with the first chamber of the water separator; and
a drying device, which is in communication with the second heavy component discharge port and configured to dry and crystallize a heavy component substance from the second thin film evaporator to acquire lithium bis(fluorosulfonyl)imide,
the method comprising:
a feeding step, in which the product liquid containing lithium bis(fluorosulfonyl)imide, water, and other solvents is conveyed into the first thin film evaporator via the first feed port;
a first evaporation separation step, in which a light component substance separated by the first thin film evaporator enters the water separator via the first light component discharge port for separation and recovery in the water separator, and a heavy component substance separated by the first thin film evaporator enters the second thin film evaporator via the first heavy component discharge port and the second feed port;
a second evaporation separation step, in which a light component substance separated by the second thin film evaporator enters the water separator via the second light component discharge port for separation and recovery in the water separator, and a heavy component substance separated by the second thin film evaporator is conveyed out via the second heavy component discharge port; and
a drying step, in which the heavy component substance from the second thin film evaporator is dried and crystallized in the drying device to acquire lithium bis(fluorosulfonyl)imide,
the water removal and recovery method further comprising a light component separation step, in which the light component substance entering the first chamber of the water separator contains immiscible water and organic phase solvents, and the organic phase solvents in the first chamber being able to overflow over the partition plate into the second chamber of the water separator.
